(19) United States
(12) Patent Application Publication
(10) Pub. No.: US 2017/0229077 A1
(43) Pub. Date: Aug. 10, 2017

(54) LIQUID CRYSTAL DISPLAY PANEL AND ELECTRONIC DEVICE ADOPTING LIQUID CRYSTAL DISPLAY PANEL THEREOF

(71) Applicant: Wuhan China Star Optoelectronics Technology Co., Ltd., Wuhan, Hubei (CN)

(72) Inventors: Chung-hung HUANG, Shenzhen, Guangdong (CN); Yingqi WANG, Shenzhen, Guangdong (CN); Yun HAN, Shenzhen, Guangdong (CN)

(73) Assignee: Wuhan China Star Optoelectronics Technology Co., Ltd., Wuhan, Hubei (CN)

(21) Appl. No.: 14/905,818

(22) PCT Filed: Dec. 29, 2015
(86) PCT No.: PCT/CN2015/099628

§ 371 Date: Jan. 17, 2016

(30) Foreign Application Priority Data
Dec. 2, 2015 (CN) 201510875982.3

(51) Int. Cl. G09G 3/36; G02F 1/1362; G02F 1/1343

(52) U.S. Cl. CPC G09G 3/3614; G02F 1/134336; G02F 1/136286; G09G 2320/0247; G02F 2201/121; G02F 2001/134345

(57) ABSTRACT

The present disclosure provides a liquid crystal display panel, which includes a first control line, a second control line, a plurality of sub pixel columns and a plurality of strip common electrodes, the first control line and the second control line are spacedly disposed in parallel along a X axis direction, the plurality of sub pixel columns and the plurality of strip common electrodes are spacedly disposed in parallel along a Y axis direction, each of the strip common electrodes covers at least one of the sub pixel columns, the strip common electrodes in odd columns are connected to the first control line, the strip common electrodes in even columns are connected to the second control line. In addition the present disclosure further provides an electronic device. The liquid crystal display panel may achieve the columns between the sub pixel columns or the pixel columns to rotate.

### CROSS-REFERENCE TO RELATED APPLICATIONS

This application claims the benefit of, and priority to, Chinese Patent Application No. 201510875982.3, filed Dec. 2, 2015, titled “liquid crystal display panel and electronic device adopting liquid crystal display panel thereof”, the entire contents of which are incorporated by reference herein in its entirety.

### FIELD OF THE INVENTION

The disclosure is related to liquid crystal display technology field, and more particular to a liquid crystal display panel and an electronic device adopting the liquid crystal display panel.

### BACKGROUND OF THE INVENTION

With the development of the liquid crystal display technology, the resolution of the liquid crystal display panel is higher and higher, thereby greatly increasing the fineness of the display frame and the visual experience effect. However, since the pixel points of the liquid crystal display panel are greatly increased, it causes the increase of the power consumption and the frame flicker. In the thin film transistor liquid crystal display (TFT-LCD), the polarity reversal manner of the pixel point voltage adopts the row reversal when the resolution is low and adopts the column reversal when the resolution is high, so as to decrease the flicker level of the display frame and increase the display quality.

However, in the existing TFT-LCD display screen, the indium tin oxide (ITO) for forming the common (COM) electrode is the entire surface design, as shown in FIG. 1. The blocks R, G and B respectively indicate the sub pixels R, G and B of the TFT-LCD display screen, the ITO of the COM electrode covers the sub pixels R, G and B and is connected to the TFT substrate through a line at the edge and then connected to the driver IC. Since all the pixels share one COM voltage, when the display screen of this structure adopts an alternating current COM voltage to drive, it does not perform the column reversal and the point reversal. If adopting the row reversal, the waveform of the alternating current COM voltage and the data (DATA) voltage of the data line is shown in FIG. 2. A variation range of the DATA voltage outputted by the driver IC is 4.5V. Since the COM voltage changes with the DATA voltage, if the resolution of the display screen is 1920×1080, the frequency of the COM voltage may be up to 115 kHz. The equivalent impedance of the COM electrode with the entire surface design is too large, such that the response of the COM electrode is slow and the delay is larger when the COM voltage changes, thereby affecting the normal display of the display screen.

Currently, since the resolution of the user terminal, such as a mobile phone, a tablet computer, etc., is higher, it must adopt the direct current COM voltage to drive, so as to avoid the alternating current COM voltage from being fast to affect the normal display of the display screen. When adopting the direct current COM voltage to drive, the waveform of the COM voltage and the DATA voltage is shown in FIG. 3. As can be seen from FIG. 3, a variation range of the DATA voltage is 9V and the variation range thereof is twice when adopting the alternating current COM voltage to drive, thereby undoubtedly increasing the power consumption of the display screen.

### SUMMARY OF THE INVENTION

In view of the above problems of the prior art, the present disclosure provides a liquid crystal display, wherein a common electrode is set as a plurality of strip electrodes which are disposed in parallel, and the strip common electrodes in odd columns and the strip common electrodes in even columns are respectively controlled by adopting an alternating current COM voltage, thereby achieving a reverse column driving when a high-resolution display, so as to decrease a flicker level of the display frame, increase the display quality and decrease the power consumption.

In addition, the present disclosure further an electronic device adopting the liquid crystal display panel.

A liquid crystal display panel, which includes a first control line, a second control line and a plurality of strip common electrodes, wherein the first control line and the second control line are spacedly disposed in parallel along a X axis direction, the plurality of sub pixel columns and the plurality of strip common electrodes are spacedly disposed in parallel along a Y axis direction, each of the strip common electrodes covers at least one of the sub pixel columns, the strip common electrodes in odd columns are connected to the first control line, the strip common electrodes in even columns are connected to the second control line, the first control line is used for providing a first driving voltage for the strip common electrodes in odd columns, and the second control line is used for providing a second driving voltage for the strip common electrodes in even columns.

In one embodiment, each of the strip common electrodes covers one sub pixel column, the strip common electrodes in odd columns provide a first common voltage to the sub pixel columns in odd columns through the first driving voltage, and the strip common electrodes in even columns provide a second common voltage to the sub pixel columns in even columns through the second driving voltage.

In one embodiment, the first common voltage on the strip common electrodes in odd columns and the second common voltage on the strip common electrodes in even columns are an alternating current voltage with reverse phase, and the alternating current voltage with reverse phase is used for driving a column reversal between the sub pixel columns covered by the strip common electrodes in odd columns and the sub pixel columns covered by the strip common electrodes in even columns.

In one embodiment, each of the strip common electrodes covers two adjacent sub pixel columns, the strip common electrodes in odd columns provide a first common voltage to the two adjacent sub pixel columns covered by the strip common electrodes in odd columns through the first driving voltage, and the strip common electrodes in even columns provide a second common voltage to the two adjacent sub pixel columns covered by the strip common electrodes in even columns through the second driving voltage.

In one embodiment, the first common voltage on the strip common electrodes in odd columns and the second common voltage on the strip common electrodes in even columns are an alternating current voltage with reverse phase, and the alternating current voltage with reverse phase is used for driving a plurality of columns between the two adjacent sub pixel columns covered by the strip common electrodes in odd columns and the two adjacent sub pixel columns covered by the strip common electrodes in even columns to rotate.

In one embodiment, each of the strip common electrodes covers three adjacent sub pixel columns, the strip common electrodes in odd columns provide a first common voltage to the three adjacent sub pixel columns covered by the strip common electrodes in odd columns through the first driving voltage, and the strip common electrodes in even columns provide a second common voltage to the three adjacent sub pixel columns covered by the strip common electrodes in even columns through the second driving voltage.

In one embodiment, the three adjacent sub pixel columns forms one pixel column, the first common voltage on the strip common electrodes in odd columns and the second common voltage on the strip common electrodes in even columns are an alternating current voltage with reverse phase, and the alternating current voltage with reverse phase is used for driving a pixel column between the pixel column covered by the strip common electrodes in odd columns and the pixel column covered by the strip common electrodes in even columns to rotate.

In one embodiment, the liquid crystal display panel further comprises a plurality of data lines, each of the data lines is used for providing a data voltage to one sub pixel column, and a polarity of the data voltages of the sub pixel columns covered by the strip common electrodes in odd columns and a polarity of the data voltages of the sub pixel columns covered by the strip common electrodes in even columns are reverse.

An electronic device, which includes a liquid crystal display panel, and the liquid crystal display panel includes a first control line, a second control line and a plurality of strip common electrodes, wherein the first control line and the second control line are spacedly disposed in parallel along a X axis direction, the plurality of sub pixel columns and the plurality of strip common electrodes are spacedly disposed in parallel along a Y axis direction, each of the strip common electrodes covers at least one of the sub pixel columns, the strip common electrodes in odd columns are connected to the first control line, the strip common electrodes in even columns are connected to the second control line, the first control line is used for providing a first driving voltage for the strip common electrodes in odd columns, and the second control line is used for providing a second driving voltage for the strip common electrodes in even columns.

In one embodiment, each of the strip common electrodes covers one sub pixel column, the strip common electrodes in odd columns provide a first common voltage to the sub pixel columns in odd columns through the first driving voltage, and the strip common electrodes in even columns provide a second common voltage to the sub pixel columns in even columns through the second driving voltage.

In one embodiment, the first common voltage on the strip common electrodes in odd columns and the second common voltage on the strip common electrodes in even columns are an alternating current voltage with reverse phase, and the alternating current voltage with reverse phase is used for driving a column reversal between the sub pixel columns covered by the strip common electrodes in odd columns and the sub pixel columns covered by the strip common electrodes in even columns.

In one embodiment, each of the strip common electrodes covers two adjacent sub pixel columns, the strip common electrodes in odd columns provide a first common voltage to the two adjacent sub pixel columns covered by the strip common electrodes in odd columns through the first driving voltage, and the strip common electrodes in even columns provide a second common voltage to the two adjacent sub pixel columns covered by the strip common electrodes in even columns through the second driving voltage.

In one embodiment, the first common voltage on the strip common electrodes in odd columns and the second common voltage on the strip common electrodes in even columns are an alternating current voltage with reverse phase, and the alternating current voltage with reverse phase is used for driving a plurality of columns between the two adjacent sub pixel columns covered by the strip common electrodes in odd columns and the two adjacent sub pixel columns covered by the strip common electrodes in even columns to rotate.

In one embodiment, each of the strip common electrodes covers three adjacent sub pixel columns, the strip common electrodes in odd columns provide a first common voltage to the three adjacent sub pixel columns covered by the strip common electrodes in odd columns through the first driving voltage, and the strip common electrodes in even columns provide a second common voltage to the three adjacent sub pixel columns covered by the strip common electrodes in even columns through the second driving voltage.

In one embodiment, the three adjacent sub pixel columns forms one pixel column, the first common voltage on the strip common electrodes in odd columns and the second common voltage on the strip common electrodes in even columns are an alternating current voltage with reverse phase, and the alternating current voltage with reverse phase is used for driving a pixel column between the pixel column covered by the strip common electrodes in odd columns and the pixel column covered by the strip common electrodes in even columns to rotate.

In one embodiment, the liquid crystal display panel further comprises a plurality of data lines, each of the data lines is used for providing a data voltage to one sub pixel column, and a polarity of the data voltages of the sub pixel columns covered by the strip common electrodes in odd columns and a polarity of the data voltages of the sub pixel columns covered by the strip common electrodes in even columns are reverse.

The liquid crystal display panel is configured with the plurality of strip common electrodes, and each of the strip common electrodes covers one sub pixel column. The strip common electrodes in odd columns are connected through the first control line and the strip common electrodes in even columns are connected through the second control line. The first control line and the second control line respectively control the strip common electrodes in odd columns and the strip common electrodes in even columns, thereby driving a plurality of columns of the liquid crystal display panel to rotate. Therefore, a flicker level of the display frame is decreased, the display quality is increased and the power consumption is decreased.

### BRIEF DESCRIPTION OF THE DRAWINGS

In order to more clearly illustrate the prior art or the embodiments or aspects of the practice of the disclosure, the accompanying drawings for illustrating the prior art or the embodiments of the disclosure are briefly described as below. It is apparently that the drawings described below are merely some embodiments of the disclosure, and those skilled in the art may derive other drawings according the drawings described below without creative endeavor.

FIG. 1 is a structure schematic view of a liquid crystal display panel in the prior art;

FIG. 2 is a schematic view of a voltage waveform of the liquid crystal display panel under an alternating current COM voltage driving of FIG. 1;

FIG. 3 is a schematic view of a voltage waveform of the liquid crystal display panel under a direct current COM voltage driving of FIG. 1;

FIG. 4 is a structure schematic view of a liquid crystal display panel according to a first embodiment of the present disclosure;

FIG. 5 is a schematic view of a voltage waveform of the liquid crystal display panel under an alternating current COM voltage driving of FIG. 4;

FIG. 6 is a structure schematic view of a liquid crystal display panel according to a second embodiment of the present disclosure; and

FIG. 7 is a structure schematic view of a liquid crystal display panel according to a third embodiment of the present disclosure.

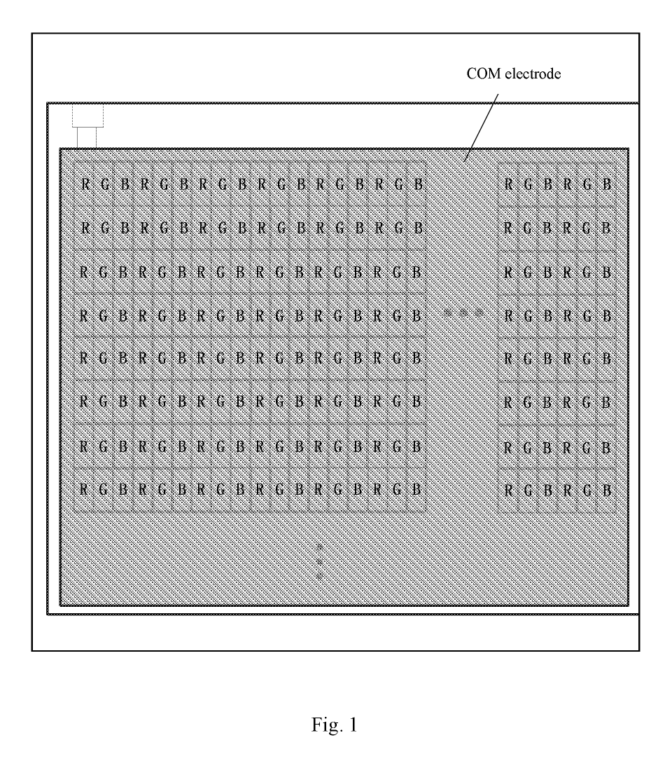

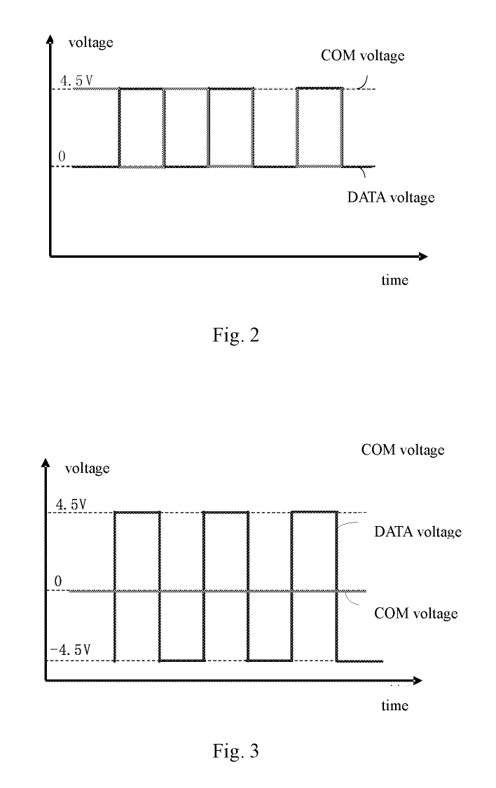

### DETAILED DESCRIPTION

The following description with reference to the accompanying drawings is provided to clearly and completely explain the exemplary embodiments of the present disclosure. It is apparent that the following embodiments are merely some embodiments of the present disclosure rather than all embodiments of the present disclosure. According to the embodiments in the present disclosure, all the other embodiments attainable by those skilled in the art without creative endeavor belong to the protection scope of the present disclosure.

For convenience of the description, the space relative terms, such as “beneath,” “under,” “lower,” “above”, “upper”, may be used to describe a relationship of one element or feature and another element(s) or feature(s) as shown in the figure. It should be understood that an element or layer is referred to “on” another element or layer, and “connected to” or “coupled to” another element or layer, it may be directly on another element or layer, directly connected to or coupled to another element or layer or it may exist the intervening element or layer. Otherwise, when an element or layer is referred to “directly on” another element or layer, and “directly connected to” or “directly coupled to” another element or layer, it may not exist the intervening element or layer.

It should be understood that the term used herein is only used for describing the particular embodiments, but not intended to limit the present disclosure. When used herein, unless the context otherwise expressly stated herein, the singular forms “a” and “the” are intended to include the plural forms. Further, when used in the specification, the term “include” and/or “comprise” indicates the presence of feature, integer, step, operation, element and/or component, but does not exclude the presence or increase of one or more other features, integers, steps, operations, elements, components and/or combinations thereof, or increase.

Unless otherwise defined, all terms (including the technical terms and the scientific terms) used here have the same meanings which the ordinary skill in the art are commonly understood. It should be further understood that besides the terms defined by the universal dictionary, it should be interpreted as having a meaning in the context of the relevant art consistent with their meaning, and should not be interpreted in an idealized or overly formal sense, unless expressly so defined here.

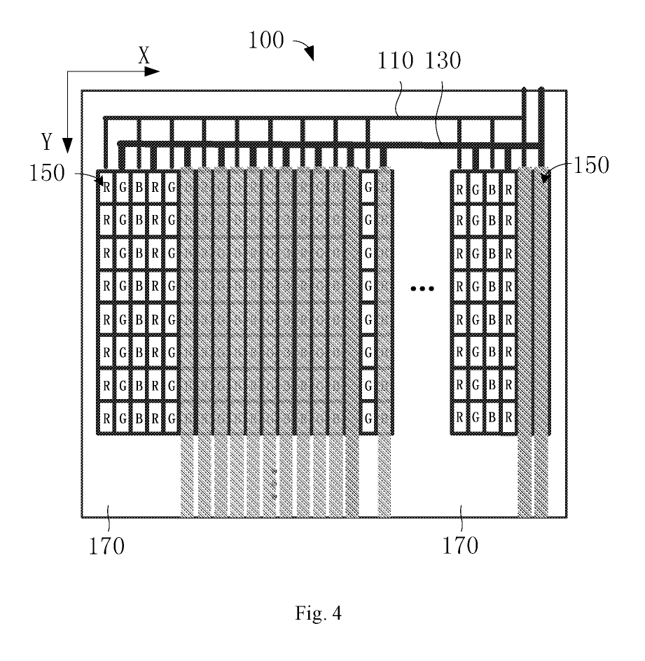

Please refers to FIG. 4, the present disclosure provides a liquid crystal display panel 100, which includes a first control line 110, a second control line 130, a plurality of data lines (not shown), a plurality of sub pixel columns 150 and a plurality of strip common electrodes 170. The first control line 110 and the second control line 130 are spacedly disposed in parallel along a X axis direction. The plurality of sub pixel columns 150 and the plurality of strip common electrodes 170 are spacedly disposed in parallel along a Y axis direction. The same one data line provides a data voltage to each of the plurality of sub pixel columns 150. Each of the strip common electrodes 170 covers at least one of the sub pixel columns 150, so as to provides a common voltage to the at least one of the sub pixel columns 150.

Each of the sub pixel columns 150 includes a plurality of sub pixel units, and the sub pixel units of each of the sub pixel columns 150 are connected to the same one data line. As shown in FIG. 4, R indicates a red sub pixel unit, G indicates a green sub pixel unit, and B indicates a blue sub pixel unit. Each of the sub pixel columns includes a plurality of sub pixel units with the same type, such as one sub pixel unit 150 may includes a plurality of red sub pixel units R or a plurality of green sub pixel units G or a plurality of blue sub pixel units B. Along the X axis direction (a direction indicated by an arrow in the X axis in FIG. 4 is a positive direction of the X axis), starting from a first sub pixel column, three successive adjacent sub pixel columns 150 are configured as one pixel column. Correspondingly, three sub pixel units R, G and B located on the same one row in each of the pixel columns are configured as one pixel unit, and each of the pixel columns includes a plurality of pixel units.

In the plurality of strip common electrodes 170, along the X axis direction, the strip common electrodes 170 in odd columns are connected to the first control line 110, and the strip common electrodes 170 in even columns are connected to the second control line 130. The first control line 110 is used for providing a first driving voltage for the strip common electrodes 170 in odd columns, so as to provide a first common voltage to at least one sub pixel column 150 covered by the strip common electrodes 170 in odd columns through the first driving voltage. The second control line 130 is used for providing a second driving voltage for the strip common electrodes 170 in even columns, so as to provides a second common voltage to at least one sub pixel column 150 covered by the strip common columns 170 in even columns through the second driving voltage.

In the embodiment, assuming that a resolution of the liquid crystal display panel 100 is 1920×1080, the liquid crystal display panel 100 includes 1080×3=3240 sub pixel columns 150. Correspondingly, the liquid crystal display panel 100 may includes 3240 strip common electrodes 170, and each of the strip common electrodes 170 covers one sub pixel column 150. Along the X axis direction, the strip common electrodes 170 in odd columns are connected to the first control line 110, so as to provide the first common voltage to the sub pixel columns 150 in odd columns in the X axis direction through the first driving voltage of the first control line 110. Along the X axis direction, the strip common electrodes 170 in even columns are connected to the second control line 130, so as to provide the second common voltage to the sub pixel columns 150 in odd columns in the X axis direction through the second driving voltage of the second control line 110.

When the resolution of the liquid crystal display panel 100 is higher (such as 1920×1080), a column reversal driving manner may be adopted to drive the liquid crystal display panel for displaying, so as to decrease a flicker level of the display frame, increase the display quality and decrease the power consumption. When adopting the column reversal driving, along the X axis direction, a polarity of the data voltages of the data lines corresponding to the sub pixel columns 150 in odd columns and a polarity of the data voltages of the data lines corresponding to the sub pixel columns 150 in even columns are reverse. Therefore, for the data voltage with the different polarities, the first control line 110 and the second control line 130 respectively provide an alternating current voltage with reverse phase, thereby achieving the column reversal driving of the sub pixel sub columns 150 in odd columns and the sub pixel sub columns 150 in even columns.

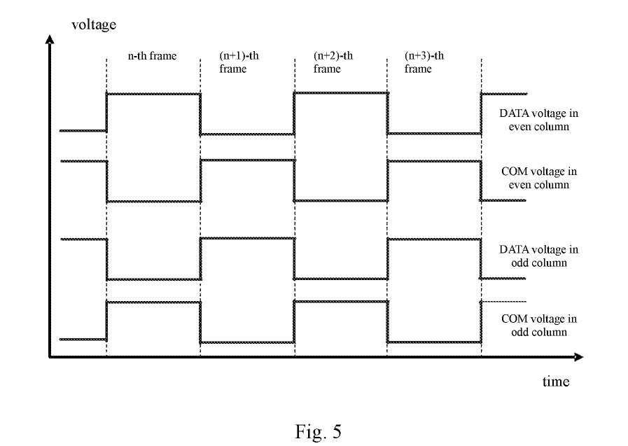

Please refers to FIG. 5, the DATA voltage of the data line corresponding to the sub pixel column 150 in odd column, the COM voltage of the strip common electrode in odd column, the DATA voltage of the data line corresponding to the sub pixel column 150 in even column and the COM voltage of the strip common electrode in even column are shown in FIG. 5. Specifically, assuming that a maximum value of the alternating current COM voltage is 4.5V and a minimum value of the alternating current COM voltage is 0V, a variation range of the DATA voltage of the data line is also 0V-4.5V. In n-th frame, assuming that the DATA voltage of the data line corresponding to the sub pixel column 150 in odd column is 0V and the DATA voltage of the data line corresponding to the sub pixel column 150 in even column is 4.5V, the first control line 110 provides the COM voltage with 4.5V to the strip common electrode 170 in odd column and the second control line 130 provides the COM voltage with 0V to the strip common electrode 170 in even column. In n+1-th frame, the DATA voltage of the data line corresponding to the sub pixel column 150 in odd column is reversed from 0V to 4.5V and the DATA voltage of the data line corresponding to the sub pixel column 150 in even column is reversed from 4.5V to 0V, the first control line 110 provides the COM voltage with 0V to the strip common electrode 170 in odd column and the second control line 130 provides the COM voltage with 4.5V to the strip common electrode 170 in even column. Alternately, the COM voltage of the strip common electrode 170 in odd column and the COM voltage of the strip common electrode 170 in even column only need reversing once per frame, so as to achieve the column reversal driving, i.e. a reverse frequency of the alternating current COM voltage equals to the frame frequency of the liquid crystal display panel 100, such as 60 Hz in the embodiment. Simultaneously, the alternating current COM voltage is adopted to drive, such that the variation range of the DATA voltage of the data line with respect to the direct current COM voltage adopted to drive is significantly decreased, it is advantageous to decrease the power consumption of the liquid crystal display panel 100.

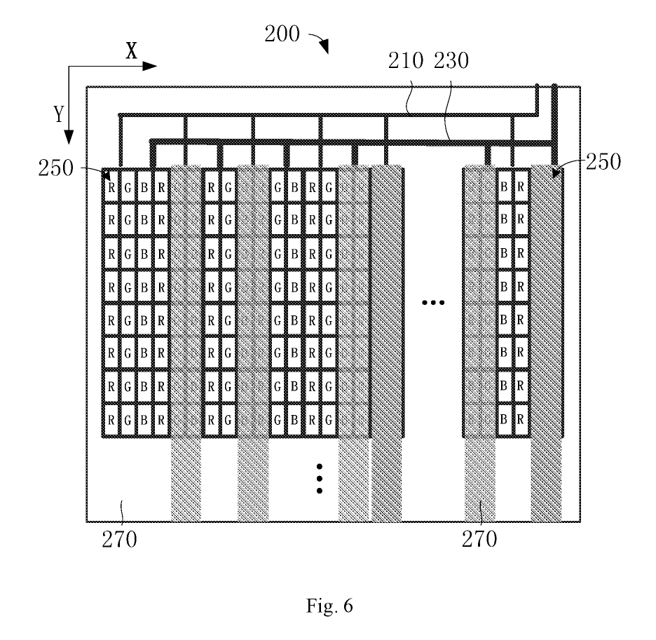

Please refers to FIG. 6, the present disclosure further provides a liquid crystal display panel 200, which a first control line 210, a second control line 230, a plurality of data lines (not shown), a plurality of sub pixel columns 250 and a plurality of strip common electrodes 270. The first control line 210 and the second control line 230 are spacedly disposed in parallel along a X axis direction. The plurality of sub pixel columns 250 and the plurality of strip common electrodes 270 are spacedly disposed in parallel along a Y axis direction. The same one data line provides a data voltage to each of the plurality of sub pixel columns 250. Each of the strip common electrodes 270 covers two adjacent sub pixel columns 250 so as to provide a common voltage to the two adjacent sub pixel columns 250 For example, along the X axis direction (a direction indicated by an arrow in the X axis in FIG. 6 is a positive direction of the X axis), a first strip common electrode 270 covers a first sub pixel column 250 and a second sub pixel column 250 adjacent to the first sub pixel column.

In the plurality of strip common electrodes 270, along the X axis direction, strip common electrodes 270 in odd columns are connected to the first control line 210 and the strip common electrodes 270 in even columns are connected to the second control line 230. The first control line 210 is used for providing a first driving voltage to the strip common electrodes 270 in odd columns, so as to provide a first common voltage to the two adjacent sub pixel columns 250 covered by the strip common electrodes 270 in odd columns through the first driving voltage. The second control line 230 is used for providing a second driving voltage to the strip common electrodes 270 in even columns, so as to provide a second common voltage to the two adjacent sub pixel columns covered by the strip common electrodes 270 in even columns through the second driving voltage.

In the embodiment, the first control line 210 and the second control line 230 respectively provide an alternating current COM voltage with reverse phase, thereby driving a plurality of columns between the two adjacent sub pixel columns 250 covered by the strip common electrodes 270 in odd columns and the two adjacent sub pixel columns 250 covered by the strip common electrodes 270 in even columns to rotate.

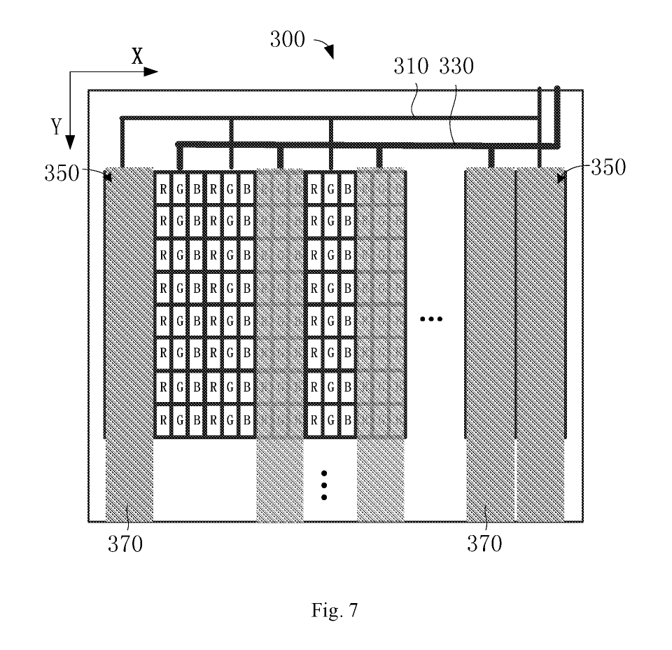

Please refers to FIG. 7, the present disclosure further provides a liquid crystal display panel 300, which a first control line 310, a second control line 330, a plurality of data lines (not shown), a plurality of sub pixel columns 350 and a plurality of strip common electrodes 370. The first control line 310 and the second control line 330 are spacedly disposed in parallel along a X axis direction. The plurality of sub pixel columns 350 and the plurality of strip common electrodes 370 are spacedly disposed in parallel along a Y axis direction. The same one data line provides a data voltage to each of the plurality of sub pixel columns 350. Each of the strip common electrodes 370 covers three adjacent sub pixel columns 350, so as to provide a common voltage to the three adjacent sub pixel columns 350.

Specifically, along the X axis direction (a direction indicated by an arrow in the X axis in FIG. 7 is a positive direction of the X axis), starting from a first sub pixel column, three successive adjacent sub pixel columns 150 are configured as one pixel column. In the embodiment, each of the strip common electrodes 370 covers one sub pixel column, so as to provide a common voltage to the sub pixel column.

In the plurality of strip common electrodes 370, along the X axis direction, the strip common electrodes 370 in odd columns are connected to the first control line 310 and the strip common electrodes 370 in even columns are connected to the second control line 330. The first control line 310 is used for providing a first driving voltage to the strip common electrodes 370 in odd columns, so as to provide a first common voltage to the sub pixel columns covered by the strip common electrodes 370 in odd columns through the first driving voltage. The second control line 330 is used for providing a second driving voltage to the strip common electrodes 370 in even columns, so as to provide a second common voltage to the sub pixel columns covered by the strip common electrodes 370 in even columns through the second driving voltage.

In the embodiment, the first control line 310 and the second control line 330 respectively provide an alternating current COM voltage with reverse phase, thereby driving a plurality of columns between the sub pixel columns covered by the strip common electrodes 370 in odd columns and the sub pixel columns covered by the strip common electrodes 370 in even columns to rotate.

It should be understood that besides the embodiments as shown in FIG. 4, FIG. 6 and FIG. 7, each of the strip common electrodes of the liquid crystal display panel may covers four adjacent sub pixel columns, five adjacent sub pixel columns or more sub pixel columns. The strip common electrodes in odd columns are connected to the first control line and the strip common electrodes in even columns are connected to the second control line. The first control line and the second control line respectively provide an alternating current COM voltage with reverse phase, thereby driving a plurality of columns between the sub pixel columns covered by the strip common electrodes in odd columns and the sub pixel columns covered by the strip common electrodes in even columns to rotate.

It should be understood that the liquid crystal display panel of the embodiment of the present disclosure further includes a driver IC (not shown), the first control line and the second control line are connected to the driver IC and the driver IC is used for respectively providing a driving voltage with reverse phase to the first control line and the second control line, thereby respectively providing an alternating current COM voltage with reverse phase to the sub pixel columns covered by the strip common electrodes in odd columns and the sub pixel columns covered by the strip common electrodes in even columns through the first control line and the second control line, so as to drive the sub pixel columns or the pixel columns to rotate.

In addition, the present disclosure further provides an electronic device adopting the liquid crystal display panel. The electronic device includes the liquid crystal display panel of any one embodiment in FIG. 4, FIG. 6 and FIG. 7. It should be understood that the electronic device may be, but not limited to, a mobile phone, a tablet computer, a notebook computer, a digital picture frame, a liquid crystal display, a liquid crystal television, etc.

The liquid crystal display panel is configured with the plurality of strip common electrodes, and each of the strip common electrodes covers one sub pixel column. The strip common electrodes in odd columns are connected through the first control line and the strip common electrodes in even columns are connected through the second control line. The first control line and the second control line respectively control the strip common electrodes in odd columns and the strip common electrodes in even columns, thereby respectively providing an alternating current COM voltage with reverse phase to the sub pixel columns covered by the strip common electrodes in odd columns and the sub pixel columns covered by the strip common electrodes in even columns through the strip common electrodes in odd columns and the strip common electrodes in even columns, so as to drive a plurality of columns of the liquid crystal display panel to rotate. Therefore, a flicker level of the display frame is decreased, the display quality is increased and the power consumption is decreased.

The above disclosure is merely an embodiment of the disclosure and does not intend to limit the claim scope of the disclosure. Those having ordinary knowledge in the related art may realize all or part of the process to achieve the above embodiments and may conduct equivalent variation on the claims of the disclosure, which belongs to the scope covered by the disclosure.

What is claimed is:

1. A liquid crystal display panel, comprising a plurality of sub pixel columns, wherein the liquid crystal display panel further comprises a first control line, a second control line and a plurality of strip common electrodes, wherein the first control line and the second control line are spacedly disposed in parallel along a X axis direction, the plurality of sub pixel columns and the plurality of strip common electrodes are spacedly disposed in parallel along a Y axis direction, each of the strip common electrodes covers at least one of the sub pixel columns, the strip common electrodes in odd columns are connected to the first control line, the strip common electrodes in even columns are connected to the second control line, the first control line is used for providing a first driving voltage for the strip common electrodes in odd columns, and the second control line is used for providing a second driving voltage for the strip common electrodes in even columns.

2. The liquid crystal display panel according to claim 1, wherein each of the strip common electrodes covers one sub pixel column, the strip common electrodes in odd columns provide a first common voltage to the sub pixel columns in odd columns through the first driving voltage, and the strip common electrodes in even columns provide a second common voltage to the sub pixel columns in even columns through the second driving voltage.

3. The liquid crystal display panel according to claim 2, wherein the first common voltage on the strip common electrodes in odd columns and the second common voltage on the strip common electrodes in even columns are an alternating current voltage with reverse phase, and the alternating current voltage with reverse phase is used for driving a column reversal between the sub pixel columns covered by the strip common electrodes in odd columns and the sub pixel columns covered by the strip common electrodes in even columns.

4. The liquid crystal display panel according to claim 1, wherein each of the strip common electrodes covers two adjacent sub pixel columns, the strip common electrodes in odd columns provide a first common voltage to the two adjacent sub pixel columns covered by the strip common electrodes in odd columns through the first driving voltage, and the strip common electrodes in even columns provide a second common voltage to the two adjacent sub pixel columns covered by the strip common electrodes in even columns through the second driving voltage.

5. The liquid crystal display panel according to claim 4, wherein the first common voltage on the strip common electrodes in odd columns and the second common voltage on the strip common electrodes in even columns are an alternating current voltage with reverse phase, and the alternating current voltage with reverse phase is used for driving a plurality of columns between the two adjacent sub pixel columns covered by the strip common electrodes in odd columns and the two adjacent sub pixel columns covered by the strip common electrodes in even columns to rotate.

6. The liquid crystal display panel according to claim 1, wherein each of the strip common electrodes covers three adjacent sub pixel columns, the strip common electrodes in odd columns provide a first common voltage to the three adjacent sub pixel columns covered by the strip common electrodes in odd columns through the first driving voltage, and the strip common electrodes in even columns provide a second common voltage to the three adjacent sub pixel columns covered by the strip common electrodes in even columns through the second driving voltage.

7. The liquid crystal display panel according to claim 6, wherein the three adjacent sub pixel columns forms one pixel column, the first common voltage on the strip common electrodes in odd columns and the second common voltage on the strip common electrodes in even columns are an alternating current voltage with reverse phase, and the alternating current voltage with reverse phase is used for driving a pixel column between the pixel column covered by the strip common electrodes in odd columns and the pixel column covered by the strip common electrodes in even columns to rotate.

8. The liquid crystal display panel according to claim 1, wherein the liquid crystal display panel further comprises a plurality of data lines, each of the data lines is used for providing a data voltage to one sub pixel column, and a polarity of the data voltages of the sub pixel columns covered by the strip common electrodes in odd columns and a polarity of the data voltages of the sub pixel columns covered by the strip common electrodes in even columns are reverse.

9. An electronic device, comprising a liquid crystal display panel, and the liquid crystal display panel comprises a plurality of sub pixel columns, wherein the liquid crystal display panel further comprises a first control line, a second control line and a plurality of strip common electrodes, wherein the first control line and the second control line are spacedly disposed in parallel along a X axis direction, the plurality of sub pixel columns and the plurality of strip common electrodes are spacedly disposed in parallel along a Y axis direction, each of the strip common electrodes covers at least one of the sub pixel columns, the strip common electrodes in odd columns are connected to the first control line, the strip common electrodes in even columns are connected to the second control line, the first control line is used for providing a first driving voltage for the strip common electrodes in odd columns, and the second control line is used for providing a second driving voltage for the strip common electrodes in even columns.

10. The electronic device according to claim 9, wherein each of the strip common electrodes covers one sub pixel column, the strip common electrodes in odd columns provide a first common voltage to the sub pixel columns in odd columns through the first driving voltage, and the strip common electrodes in even columns provide a second common voltage to the sub pixel columns in even columns through the second driving voltage.

11. The electronic device according to claim 10, wherein the first common voltage on the strip common electrodes in odd columns and the second common voltage on the strip common electrodes in even columns are an alternating current voltage with reverse phase, and the alternating current voltage with reverse phase is used for driving a column reversal between the sub pixel columns covered by the strip common electrodes in odd columns and the sub pixel columns covered by the strip common electrodes in even columns.

12. The electronic device according to claim 9, wherein each of the strip common electrodes covers two adjacent sub pixel columns, the strip common electrodes in odd columns provide a first common voltage to the two adjacent sub pixel columns covered by the strip common electrodes in odd columns through the first driving voltage, and the strip common electrodes in even columns provide a second common voltage to the two adjacent sub pixel columns covered by the strip common electrodes in even columns through the second driving voltage.

13. The electronic device according to claim 12, wherein the first common voltage on the strip common electrodes in odd columns and the second common voltage on the strip common electrodes in even columns are an alternating current voltage with reverse phase, and the alternating current voltage with reverse phase is used for driving a plurality of columns between the two adjacent sub pixel columns covered by the strip common electrodes in odd columns and the two adjacent sub pixel columns covered by the strip common electrodes in even columns to rotate.

14. The electronic device according to claim 9, wherein each of the strip common electrodes covers three adjacent sub pixel columns, the strip common electrodes in odd columns provide a first common voltage to the three adjacent sub pixel columns covered by the strip common electrodes in odd columns through the first driving voltage, and the strip common electrodes in even columns provide a second common voltage to the three adjacent sub pixel columns covered by the strip common electrodes in even columns through the second driving voltage.

15. The electronic device according to claim 14, wherein the three adjacent sub pixel columns forms one pixel column, the first common voltage on the strip common electrodes in odd columns and the second common voltage on the strip common electrodes in even columns are an alternating current voltage with reverse phase, and the alternating current voltage with reverse phase is used for driving a pixel column between the pixel column covered by the strip common electrodes in odd columns and the pixel column covered by the strip common electrodes in even columns to rotate.

16. The electronic device according to claim 9, wherein the liquid crystal display panel further comprises a plurality of data lines, each of the data lines is used for providing a data voltage to one sub pixel column, and a polarity of the data voltages of the sub pixel columns covered by the strip common electrodes in odd columns and a polarity of the data voltages of the sub pixel columns covered by the strip common electrodes in even columns are reverse.
